(19) United States
(12) Patent Application Publication
(10) Pub. No.: US 2010/0041865 A1
(43) Pub. Date: Feb. 18, 2010

(54) Conductive Polyaniline And Preparing Method Of The Same

(75) Inventors: Myung Jo Jung, Gyeonggi-do (KR); Tae Ja Kim, Gyeonggi-do (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: ELPANI CO., LTD., Gyeonggi-do (KR)

(21) Appl. No.: 12/540,719

(22) Filed: Aug. 13, 2009

(30) Foreign Application Priority Data
Aug. 13, 2008 (KR) 10-2008-0079266

(51) Int. Cl. C08G 73/00

(52) U.S. Cl. 528/422

(57) ABSTRACT

Provided are novel conductive polyanilines and a preparing method thereof, the conductive polyanilines having a remarkably improved heat-melting property and a solubility in a general solvent while maintaining a relatively high electrical conductivity by means of synthesizing a substituted polyaniline copolymer via polymerizing a substituted aniline derivative with a non-substituted aniline derivative in a set ratio, and a novel preparing method thereof.

### CROSS-REFERENCE TO RELATED APPLICATION

This application claims the benefit of Korean Patent Application 10-2008-0079266, filed on Aug. 13, 2008, which is hereby incorporated by reference in its entirety.

### FIELD OF THE INVENTION

The present disclosure relates to conductive polyanilines and a preparing method thereof. In more particular, the present disclosure relates to conductive polyanilines, which have a remarkably improved heat-melting property and solubility in a general solvent while maintaining a relatively high electrical conductivity via synthesizing a substituted polyaniline copolymer by means of polymerizing a substituted aniline derivative with a non-substituted aniline derivative in a set ratio, and a preparing method thereof.

### BACKGROUND OF THE INVENTION

A conductive plastic is a polymer which has been publicly known since Profs. A. J. Heeger, A. G. MacDiarmid and H. Shirakawa were awarded Nobel Chemical Prize in 2000. In 1977, they first reported that polyacetylene polymers become electrically conductive through a doping process. Since then, researches on the conductive plastic have been very briskly carried out.

Such conductive polymers are often called “fourth-generation plastic”, which are characterized by performing an active role like organic semiconductors instead of a passive role like insulators.

The conductive polymers have been applied in various ways depending on conductivity. For example, polymers having a conductivity ranging from about 10⁻¹³ to about 10⁻⁷ S/cm are applied to antistatic materials; polymers having a conductivity ranging from about 10⁻⁶to about 10⁻² S/cm are applied to static discharge materials; and polymers having a conductivity of 1 S/cm or more are applied to EMI shielding materials, battery electrodes, semiconductors or solar cells. With an increase in a value of the conductivity, they can be applied in more various ways.

Accordingly, the conductive polymers show electric, magnetic and optical properties like metals in addition to their own properties such as an excellent mechanical property and processability, so that they have been regarded as an important research target not only in the fields of synthetic chemistry, electrochemistry and solid state physics but also in various industrial fields due to their potential practicality.

For example, polyaniline, polypyrrole, polythiophene, poly (p-phenylene vinylene), poly (p-phenylene) and polyphenylene sulfide (PPS) have been known as an important conductive polymer for now.

Among these conductive polymers, polyaniline has attracted more attention due to its high stability in air and industrial applicability and has been expected to play a essential role in manufacturing important devices such as an organic-light-emitting diode (OLED) and a field effect transistor (FET) bringing about a revolution in the display industry in recent years.

Polyaniline is an organic polymer having an alternating ring heteroatom backbone structure and its various kinds of derivatives can be prepared by substitution on a benzene ring or a nitrogen atom. As illustrated in FIG. 1, polyaniline can be classified into emeraldine base as a partially oxidized type (y=0.5), leuco-emeraldine base as a completely reduced type (y=1.0) and pernigraniline base as a completely oxidized type (y=0.0) according to its oxidation state, as shown in the following chemical structures:

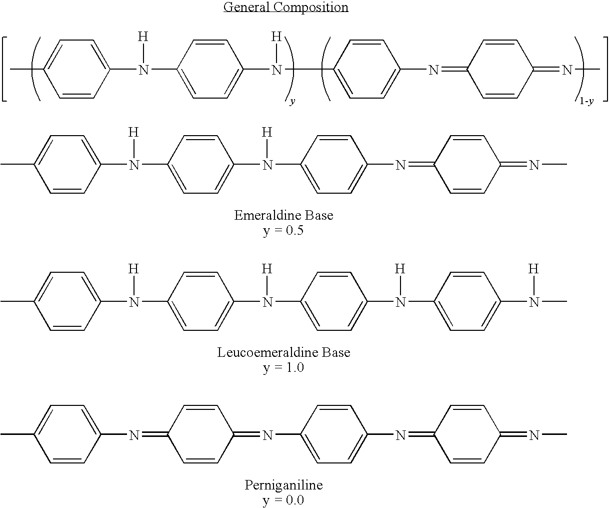

An imine nitrogen atom in the polyaniline may be entirely or partially substituted by a proton using an aqueous protonic acid solution, and if so, it is converted to an emeraldine salt having a different doping level and an electrical conductivity in forms of both powder and film is increased from about 10⁻⁸ S/cm to a range between about 1 S/cm and about 100 S/cm.

A preparing method of such polyanilines can be divided into two: one is an electrochemical method by means of an electric charge transfer reaction; and the other is a chemical oxidation method by protonation through an oxidation/reduction reaction or an acid/base reaction. It has been known that the chemical oxidation method is suitable for a mass production of polyaniline on an industrial scale.

In view of the foregoing, polyaniline has advantages in that it is relatively easily prepared and its electric property can be adjusted according to its oxidation state, in comparison to other conductive polymers. Further, using a characteristic of polyaniline being transformed from a non-conductive emeraldine base (EB) in an intermediately oxidized type to a conductive emeraldine salt (ES) by two different independent doping processes, lots of researches are being performed on its applicability to various fields such as a replacement of ITO contained in the TFD-LCD, a simplification of a semiconductor circuit process, an ultrahigh speed switch, and a non-linear optical device.

Furthermore, polyaniline has a high electrical conductivity after being doped, and both a doped polyaniline and a non-doped polyaniline have a high thermal stability and a high stability in air, so that polyaniline has been developed as a polymer capable of being applied to an electric conductive plastic, a transparent conductor, a thin film for shielding an electromagnetic wave, a secondary battery, an electrochromic device, a light emitting diode, or the like.

However, in spite of the above-described advantages of polyaniline, it has a low solubility and a poor heat-melting property due to a hydrogen bonding between polymer chains, resulting in its poor proccessability and limitations in its crystallinity and conductivity, and therefore, there are lots of difficulties in its practical use.

Accordingly, various researches have recently been done in order to improve disadvantages of polyaniline such as insolubility and non-melting property, and it has been reported that when polyaniline is doped with a large molecular organic acid such as dodecylbenzene sulfonic acid (DBSA) or camphorsulfonic acid (CSA), an interaction between the polymer chains decreases, resulting in that polyaniline becomes soluble in an organic solvent such as N-methyl-2-pyrrolidione (NMP), or chloroform or xylene, or the like.

Further, it has been reported that in case of using, in particular, m-cresol as a solvent, polyaniline has a high solubility due to a hydrogen bonding between the solvent and polyaniline so as to be transformed into an expanded coil form where a coordination structure is expanded, which results in a high conductivity of polyaniline.

Furthermore, researches on polyaniline are in progress in various ways, for example: by polymerizing polyaniline with additives such as surfactant to form micelles or stabilizers; by changing a solvent, a reaction temperature or the like so as to increase a molecular weight of a polymer as well as to improve linearity thereof; and by adding various kinds of additives when polymers are blended.

Moreover, it has been recently reported that when various side chains such as alkyl, alkoxy, benzyl and aryl are added to an aromatic ring or a nitrogen atom of aniline and then polymerized, a solubility of polyaniline is improved. In particular, it has been reported that in case of polymerizing aniline having a short side chain, such as 2-or-3-methoxyaniline or 2-or-3-ethoxyaniline, an alkoxy group serves as an electron donor and thus it is possible to obtain a conductivity almost equal to that of polyaniline.

Generally, a polymer is prepared by a polymerization process in which monomers are repeatedly connected with one another. In an addition polymerization releasing a large amount of heat during the process, a chain of reactions occurs in a very short time, and thus sometimes the reactions occur so violently as to make an explosion.

In order to control such a heat of reaction, water is often used as a reaction medium. However, most of polymers are made up of non-polar monomers which are not soluble in water, and also, the polymer prepared by a polymerization process is not soluble in water. Therefore, various kinds of heterogeneous polymerization methods have been employed in order to efficiently perform the polymerization process.

In a dispersion polymerization method, a stabilizer serving to sterically stabilize polymer particles during a polymerization process is used in order to prevent a precipitation of the prepared polymer as well as obtain stable fine polymer particles as a final form. However, when a stabilizer is used in a process of preparing a conductive polymer such as polyaniline, it is difficult to remove the stabilizer after reaction, so that there is a problem that electrical conductivity is greatly decreased.

For this reason, Prof. MacDiarmid awarded Nobel Chemical Prize in the mid-1980s implemented a reaction in an aqueous solution without using a steric stabilizer when preparing polyaniline. The method has been used worldwide as a standard method (A. G. MacDiarmid, J. C. Chaing, A. F. Richter, N. L. D. Somarisi, in L. Alcacer (ed.), Conducting Polymers, Special Applications, Reidel, Dordrecht, 1987, p. 105).

According to his method, aniline monomers dissolved in hydrochloric acid using an oxidizing agent such as ammonium persulfate in an aqueous solution are polymerized at a temperature ranging from about 1° C. to about 5° C. and then precipitates are separated and washed to synthesize polyaniline. There is no problem in the early stage of the polymerization since the aniline monomers are soluble in the hydrochloric acid aqueous solution medium, but as the size of the polymer increases, some of the polymers are precipiated, resulting in that it is difficult to increase a molecular weight and suppress side reactions.

Among emeraldine base (EB)-typed polyanilines prepared according to MacDiarmid' method, only polyanilines having a low molecular weight (intrinsic viscosity of about 0.8-1.2 dl/g) is soluble in 1-methyl-2-pyrrolidone (NMP) and emeraldine salt (ES.CSA) doped with 10-camphorsulfonic acid (CSA) is sparingly soluble in m-cresol.

A film manufactured using this solution has electrical conductivity of about 100 S/cm while emeraldine salt (ES. HCl) doped with hydrochloric acid has electrical conductivity of about 5 S/cm. In a conventional method, particularly, non-dissolved parts should be separated, and there is a limit in controlling a structure of synthesized polyanilines and increasing a molecular weight or electrical conductivity of synthesized polyanilines.

Various synthesizing methods using emulsion polymerization to solve the problems in conventional methods and improve a processability of polyanilines have been disclosed. For example, Cao et al. suggested in U.S. Pat. Nos. 5,231,631 and 5,324,453 that aniline monomers, functional protonic acid, and the like are dissolved in a polar solvent such as water and mixed with a non-polar organic solvent so as to prepare an emulsion and then an oxidizing agent is added to the prepared emulsion, whereby polyanilines are synthesized.

It has been known that emeraldine salt (ES) prepared in this way forms a complex together with polyaniline so as to be dissolved in a non-polar organic solvent such as xylene since an emulsifier serves as a dopant.

However, it is difficult to control a doping process using a functional organic acid serving as an emulsifier and it is generally expensive. Further, after polyaniline is prepared, it is difficult to be separated, so that its uses are limited. Furthermore, its electric property is not good. For example, dodecylbenzene sulfonate (DBS) has a solubility of less than 0.5% and a conductivity of about 0.1 S/cm.

Kinlen, a researcher of Monsanto prepared a polyaniline salt having a solubility of about 1% or more in a non-polar solvent by a method in which a reverse emulsion prepared using an organic solvent such as 2-butoxyethanol soluble in water and an organic acid non-soluble in water but soluble in the organic solvent, serving as a hydrophobic emulsifier, is mixed with aniline monomers and a radical initiator for polymerization, and then an organic layer containing a polyaniline salt and an aqueous solution layer containing the radical initiator or non-reacted materials are separated (refer to U.S. Pat. No. 5,567,356 and Macromolecules, 31, 1745 (1998)).

According to this method, since the radical initiator layer and the monomer layer are separated from each other, it is difficult to polymerize them, and also, since it is difficult to control doping, the prepared polyaniline has a low electrical conductivity. It has been reported that a polyaniline salt prepared using, e.g., dinonylnaphthalenesulfonic acid which is a hydrophobic organic acid has electrical conductivity of about 10⁻⁵ S/cm when it is formed into a pellet.

Unlike the emulsion polymerization, various methods of preparing polyaniline using dispersion polymerization, in which monomers such as aniline are completely dissolved in a reaction solvent but a prepared polymer is not dissolved under the same condition, have been reported. For example, Armes et al. reported a polymerization method in which a polymer is sterically stabilized by designing a special stablilizer and then granulated (refer to Handbook of Conducting Polymers Elsenbaumer ed. M. Dekker, New York, 1996 Vol. 1, p 423).

In most cases using the dispersion polymerization, a stabilizer is used to surround a synthesized polyaniline so as to be supplied in an aqueous solution phase. However, since the synthesized polyaniline has a particle size ranging from about 60 nm to about 300 nm, it is greatly affected by the stabilizer and it has limited uses due to its low electrical conductivity.

Furthermore, methods of preparing polyaniline in an aqueous solution containing an organic solvent have been reported. Cao et al. reported that polyaniline is prepared using various kinds of oxidizing agents and an inorganic acid but yield is not much different, and a hydrophilic organic solvent such as dimethylformamide is added to a reaction system in order to prevent a polymer from precipitating in the early stage of the reaction but it shows no effect (refer to Polymer, 30, 2305 (1989)).

Further, Geng et al. prepared a polyaniline film having a conductivity of about 10 S/cm by polymerizing aniline using an organic solvent such as ethanol, THF or acetone in an aqueous solution, but such an organic solvent has an insignificant effect on the reaction (refer to Synth. Metals, 96, 1 (1998)).

In a similar way, Angelopoulos disclosed a method of preparing about 10 or more electrically conductive polymers including polyaniline. According to this method, a precipitation rate of the polymer is controlled by controlling the amount of an oxidizing agent or adding an organic solvent, whereby a homogeneous reaction is induced in the early stage of the reaction and a molecular weight distribution is made to show from a composite peak shape a to single peak shape (refer to Korean Patent Laid-open Publication No. 1999-63696).

Further, Huang et al. synthesized polyaniline in a nano fiber shape by the method in which a reaction system where an organic layer is not mixed with an aqueous solution layer is formed and then aniline monomers are dissolved in the organic layer and an initiator and organic acid are dissolved in the aqueous solution layer, whereby a polymerization reaction occurs at an interface between the layers (refer to J. Am. Chem. Soc. 125, 314 (2003)).

As a result of a subsequent research, Huang et al. reported that when an interfacial polymerization is implemented using an organic solvent, yield of the nano fiber can be increased but it is not necessary to use the organic solvent, and instead, the nano fiber can be synthesized by rapidly mixing such reaction materials in an aqueous solution (refer to Angew. Chem. Int. Ed. 43, p 5817, 2003).

Furthermore, according to a research of Beadel et al., with respect to polyaniline prepared according to the standard preparing method suggested by MacDiarmid, its electrical conductivity is increased as a molecular weight is increased, and in order to increase the molecular weight, a reaction temperature should be lowered (refer to Synth. Met. 95, 29 (1998)).

However, when polymerization is implemented in a homogeneous aqueous solution as implemented by MacDiarmid, Cao, Geng, Angelopoulos and Huang et al., it is necessary to prevent the homogeneous aqueous solution from being frozen by generally adding a metal salt such as LiCl or CaF₂ therein in order to lower a reaction temperature. However, when such metal salt is mixed therein, it takes as long as about 48 hours or more to complete the reaction and it becomes difficult to control the reaction. Besides, when the reaction temperature is lowered, a molecular weight distribution as well as a molecular weight is increased (a degree of dispersion is about 2.5 or more).

Moreover, if aniline monomers are added to a quinonediimine group between chains, side chains are generated. Therefore, FeCl₃ as an oxidizing agent is added in the middle of the reaction in order to suppress such a generation of the side chains, or an extraction process using an organic solvent may be involved during a polymerization reaction in order to remove a by-product such as an oligomer generated when a synthesizing reaction is stopped.

Further, even in case of the emulsion polymerization or the interfacial polymerization as mentioned above, there is a high possibility that an addition reaction occurs at an ortho position as well as a para position of a benzene ring included in polyaniline main chains. Therefore, many side chains are necessarily to be generated, resulting in decreasing an electrical conductivity and a solubility.

A conductive polymer itself can not be formed into a complete linear shape, so that it cannot form a perfect order such as crystallinity. Therefore, its actual conductivity is far less than a theoretically estimated level of about 105˜106 S/cm (Kohlman et al., Phys. Rev. Lett. 78(20), 3915, 1997).

Accordingly, it is demanded to provide new conductive polyanilines having a considerably improved solubility in a general solvent such as water and an improved heat-melting property by lowering a thermal stability while maintaining a relatively high electrical conductivity as compared to conventional polyanilines, and a preparing method thereof.

### BRIEF SUMMARY OF THE INVENTION

In order to solve the above-stated technical problems, there are provided conductive polyanilines, which have a remarkably improved heat-melting property and a solubility in a general solvent while maintaining a relatively high electrical conductivity via synthesizing a substituted polyaniline copolymer by means of polymerizing a substituted aniline derivative with a non-substituted aniline derivative in a set ratio, and a preparing method thereof. Further, a particle size of these polyaniline copolymers can be controlled from about 5 nm to about 300 nm according to their composition, and their molecular weights can be increased by double or more at the same conditions for synthesizing polyanilines.

### BRIEF DESCRIPTION OF SEVERAL VIEWS OF THE DRAWINGS

The disclosure may best be understood by reference to the following description taken in conjunction with the following figures:

FIG. 1 shows H NMR spectra of monomers of (a) 2-R₁-phenylamine (where, R₁ is —OCH₂CH₂—OCH₂CH₂—OCE₃) and (b) 2-R₂-phenylamine (where, R₂ is —OCH₂CH₂—OCH₂CH₂—OCH₂CH₂—OCH₃) in accordance with the present invention;

FIG. 2 is a TEM image of the polymer prepared in Example 3 (scale bar: 20 nm);

FIG. 3 shows a view of electrical conductivity measurement of a free-standing film by a four-probe method in accordance with the present invention;

FIG. 4 shows TGA graphs obtained for (a) Pani EB, (b) PANI-S₂ with 2 mol % 2-R₁-phenylamine, (c) PANI-S₂ with 5 mol % 2-R₁-phenylamine, and (d) PANI-S₂ with 10 mol % 2-R₁-phenylamine in accordance with the present invention;

FIG. 5 shows TGA graphs obtained for (a) PANI-S₃ with 2 mol % 2-R₂-phenylamine, (b) PANI-S₃ with 5 mol % 2-R₂-phenylamine, and (c) PANI-S₃ with 10 mol % 2-R₂-phenylamine in accordance with the present invention;

FIG. 6 shows DSC graphs obtained for (a) Pani EB, (b) PANI-S₂ EB with 2 mol % 2-R₁-phenylamine, (c) PANI-S₂ EB with 5 mol % 2-R₁-phenylamine, and (d) PANI-S₂ EB with 10 mol % 2-R₁-phenylamine in accordance with the present invention;

FIG. 7 shows DSC graphs obtained for (a) Pani EB, (b) PANI-S₃ EB with 2 mol % 2-R₂-phenylamine, (c) PANI-S₃ EB with 5 mol % 2-R₂-phenylamine, and (d) PANI-S₃ EB with 10 mol % 2-R₂-phenylamine in accordance with the present invention;

FIG. 8 shows IR spectra obtained for (a) Pani EB, (b) PANI-S₂ EB with 2 mol % 2-R₁-phenylamine, (c) PANI-S₂ EB with 5 mol % 2-R₁-phenylamine, and (d) PANI-S₂ EB with 10 mol % 2-R₁-phenylamine in accordance with the present invention;

FIG. 9 shows IR spectra obtained for (a) Pani EB, (b) PANI-S₃ EB with 2 mol % 2-R₂-phenylamine, (c) PANI-S₃ EB with 5 mol % 2-R₂-phenylamine, and (d) PANI-S₃ EB with 10 mol % 2-R₂-phenylamine in accordance with the present invention;

FIG. 10 shows NMR spectra obtained for (a) PANI-S₂10 EB,(b) PANI-S₂ 5 EB (c) PANI-S₃ 5 EB (d)PANI-S₂10 EB in CD₂CH₂;

FIG. 11 shows UV absorption spectra obtained for (a) Pani EB, (b) PANI-S₂ EB with 2 mol % 2-R₁-phenylamine, (c) PANI-S₂ EB with 5 mol % 2-R₁-phenylamine, and (d) PANI-S₂ EB with 10 mol % 2-R₁-phenylamine in NMP;

FIG. 12 shows UV absorption spectra obtained for (a) Pani EB, (b) PANI-S₃ EB with 2 mol % 2-R₂-phenylamine, (c) PANI-S₃ EB with 5 mol % 2-R₂-phenylamine, and (d) PANI-S₃ EB with 10 mol % 2-R₂-phenylamine in NMP;

FIG. 13 shows UV absorption spectra obtained for (a) CSA-doped Pani ES, (b) CSA-doped PANI-S₂ ES with 2 mol % 2-R₁-phenylamine, (c) CSA-doped PANI-S₂ ES with 5 mol % 2-R₁-phenylamine, and (d) CSA-doped PANI-S₂ ES with 10 mol % 2-R₁-phenylamine in m-cresol;

FIG. 14 shows UV absorption spectra obtained for (a) CSA-doped Pani ES, (b) CSA-doped PANI-S₃ ES with 2 mol % 2-R₂-phenylamine, (c) CSA-doped PANI-S₃ ES with 5 mol % 2-R₂-phenylamine, and (d) CSA-doped PANI-S₃ ES with 10 mol % 2-R₂-phenylamine in m-cresol;

FIG. 15 shows graphs showing particle size distributions of (a) PANI-S₂ 10 ES and (b) PANI-S₃ 10 ES doped by HCl in water; and

FIG. 16 shows solubility of (a) PANI-S₂ 5, (b) PANI-S₂ 10, (c) PANI-S₃ 5 and (d) PANI-S₃ 10 in water.

### DETAILED DESCRIPTION OF THE INVENTION

The first aspect of the present invention provides a preparing method of conductive polyanilines including:
(a) setting a reaction temperature of a reactor equipped with a cooling circulator, introducing a mixture containing a protonic acid and an organic solvent with a predetermined ratio into the reactor, and cooling the reactor down to the set reaction temperature while stirring the mixture;
(b) adding an aniline derivative substituted with R represented by the following Chemical Formula 1 and a non-substituted aniline of a predetermined molar ratio in the mixture containing the protonic acid and the organic solvent, and dispersing the mixture for 30 to 35 minutes:

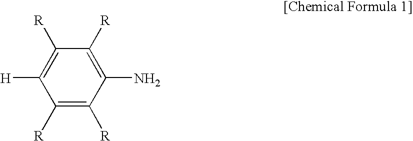

wherein, each R is independently H, a hydrophobic —(O)ₘ—(—CH₂—)ₙ—CH₃ in which m is 0 or an integer more than 0 and n is a number from 5 to 24, or a hydrophilic —(—OCE₂CH₂—)_{n′}—O(CH₂)_{m′}CH₃ CH₃ in which m′ is 0 or an integer more than 0 and n′ is an integer equal to or more than 1, providing that each R is not simultaneously H;
(c) performing a polymerizing reaction by adding dropwisely an initiator solution dissolved in a protonic acid into the reactor containing the dispersed anilines;
(d) terminating the polymerizing reaction followed by filtering the reaction solution to obtain a product from the polymerizing reaction, washing the product with a washing solvent, and then dedoping the product; and
(e) washing the product with water followed by drying to obtain a substituted polyaniline copolymer.

The second aspect of the present invention provides a conductive polyaniline, which is prepared from a monomer mixture containing an aniline derivative substituted with R represented by the above Chemical Formula 1 and a non-substituted aniline in a predetermined molar ratio using the method according to the first aspect of this invention.

It has been also found by the present inventors that, in the above preparing method of conductive polyanilines, when an 1:1 anilinium salt is previously prepared by reacting a non-substituted aniline and the substituted aniline derivative in an equivalent ratio with a protonic acid and is then used as a monomer in the above preparing method of conductive polyanilines, polymerization degree and electrical conductivity of prepared conductive polyanilines are improved as compared to the case where an substituted aniline derivative and a non-substituted aniline themselves are used as a monomer. In this regard, lone pair electrons on a nitrogen atom in an anilinium cation are not delocalized in an aniline molecule but delocalized in the anilinium cation, and thus, a direct oxidation reaction does not easily occur in the anilinium cation. However, a pernigraniline generated during the reaction easily accepts anilinium cation in a propagation stage and can be thus easily reduced by remaining anilines after its growth, whereby a desired product of a green emeraldine type is synthesized. Accordingly, in the present invention, a substituted aniline derivative, and a non-substituted aniline mixed with an anilinium salt previously prepared from a part thereof in a suitable ratio can be used as a monomer.

Accordingly, in the third aspect of this invention, a preparing method of a conductive polyaniline is provided, which is the same as the method according to the first aspect of this invention except using a monomer mixture containing an aniline derivative substituted with R represented by the above Chemical Formula 1 or anilinium hydrochloride derivative substituted with R represented by the following Chemical Formula 2, and a non-substituted aniline or anilinium hydrochloride derivative in a predetermined molar ratio:

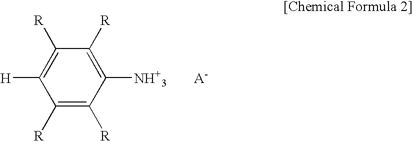

wherein, each R is independently HE, a hydrophobic —(O)ₘ—(—CH₂—)ₙ—CH₃ in which m is 0 or an integer more than 0 and n is a number from 5 to 24, or a hydrophilic —(—OCE₂CH₂—)_{n′}—O(CH₂)_{m′}CH₃ CH₃ in which m′ is 0 or an integer more than 0 and n′ is an integer equal to or more than 1, providing that each R is not simultaneously H.

The fourth aspect of the present invention provides a conductive polyaniline, which is prepared from a monomer mixture containing an aniline derivative substituted with R represented by the above Chemical Formula 1 or an anilinium hydrochloride derivative substituted with R represented by the above Chemical Formula 2, and a non-substituted aniline or anilinium hydrochloride derivative in a predetermined molar ratio.

In accordance with the present invention, when a substituted polyaniline copolymer is prepared by polymerizing a substituted aniline derivative mixed with a non-substituted aniline derivative in a predetermined molar ratio, its molecular weight decreases and its thermal stability decreases according to a content of the aniline derivative having side chains, and as a molar ratio of side chains increases or the side chains become longer, its solubility in a general solvent becomes considerably improved in comparison to conventional polyanilines.

In particular, a polyaniline copolymer emeraldine salt (ES) in which an aniline derivative having a side chain is polymerized at a ratio of about 10 mol % in accordance with the present invention is dispersed in water at a uniform size of about 220 nm, so that it can solve the problem that conventional polyanilines are processed by being dissolved only in a toxic solvent.

Further, the polyaniline copolymer prepared in accordance with the present invention has a low crystallinity or a viscosity as compared to the conventional polyanilines, and a steric hindrance due to its side chains affects on a conjugation length, thereby decreasing a conductivity to a certain extent, but it still has a relatively high electrical conductivity (up to 290 S/cm) as compared to conventional substituted polyanilines.

Hereinafter, embodiments of the present invention will be described in detail with reference to the accompanying drawings so that the present invention may be readily implemented by those skilled in the art. However, it is to be noted that the present invention is not limited to the embodiments but can be realized in various other ways.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements.

The first aspect of the present invention provides a preparing method of conductive polyanilines including:
(a) setting a reaction temperature of a reactor equipped with a cooling circulator, introducing a mixture containing a protonic acid and an organic solvent with a predetermined ratio into the reactor, and cooling the reactor down to the set reaction temperature while stirring the mixture;
(b) adding an aniline derivative substituted with R represented by the following Chemical Formula 1 and a non-substituted aniline of a predetermined molar ratio in the mixture containing the protonic acid and the organic solvent, and dispersing the mixture for 30 to 35 minutes:

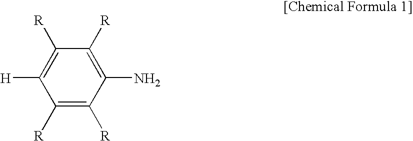

wherein, each R is independently H, a hydrophobic —(O)ₘ—(—CH₂—)ₙ—CH₃ in which m is 0 or an integer more than 0 and n is a number from 5 to 24, or a hydrophilic —(—OCE₂CH₂—)_{n′}—O(CH₂)_{m′}CH₃ CH₃ in which m′ is 0 or an integer more than 0 and n′ is an integer equal to or more than 1, providing that each R is not simultaneously H;
(c) performing a polymerizing reaction by adding dropwisely an initiator solution dissolved in a protonic acid into the reactor containing the dispersed anilines;
(d) terminating the polymerizing reaction followed by filtering the reaction solution to obtain a product from the polymerizing reaction, washing the product with a washing solvent, and then dedoping the product; and
(e) washing the product with water followed by drying to obtain a substituted polyaniline copolymer.

In one embodiment of the preparing method of conductive polyanilines according to the present invention, pH of the protonic acid may be less than 4, but the present invention is not limited thereto.

In another embodiment of the preparing method of conductive polyanilines according to the present invention, the organic solvent may be non-soluble or sparingly soluble in water, but the present invention is not limited thereto.

In another embodiment of the preparing method of conductive polyanilines according to the present invention, a molar ratio of the aniline derivative substituted with R mixed with the non-substituted aniline may be controlled with respect to a solubility of an obtained polyaniline, but the present invention is not limited thereto.

The second aspect of the present invention provides a conductive polyaniline, which is prepared from a monomer mixture containing an aniline derivative substituted with R represented by the above Chemical Formula 1 and a non-substituted aniline in a predetermined molar ratio using the method according to the first aspect of this invention.

In one embodiment of the conductive polyanilines according to the present invention, at least one R in the Chemical Formula 1 may be a hydrophobic —(O)ₘ—(—CH₂—)ₙ—CH₃ in which m is 0 or an integer more than 0 and n is a number from 5 to 24, or, a hydrophilic —(—OCH₂CH₂—)_{n′}—O(CH₂)_{m′}CH₃ CH₃ in which m′ is 0 or an integer more than 1 and n′ is an integer equal to or more than 1.

The third aspect of this invention, a preparing method of a conductive polyaniline is provided, which is the same as the method according to the first aspect of this invention except using a monomer mixture containing an aniline derivative substituted with R represented by the above Chemical Formula 1 or anilinium hydrochloride derivative substituted with R represented by the following Chemical Formula 2, and a non-substituted aniline or anilinium hydrochloride derivative in a predetermined molar ratio:

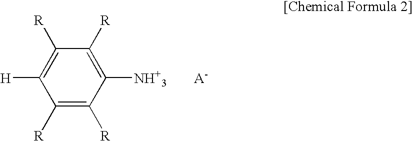

wherein, each R is independently H, a hydrophobic —(O)ₘ—(—CH₂—)ₙ—CH₃ in which m is 0 or an integer more than 0 and n is a number from 5 to 24, or a hydrophilic —(—OCE₂CH₂—)_{n′}—O(CH₂)_{m′}CH₃ CH₃ in which m′ is 0 or an integer more than 0 and n′ is an integer equal to or more than 1, providing that each R is not simultaneously H.

The fourth aspect of the present invention provides a conductive polyaniline, which is prepared from a monomer mixture containing an aniline derivative substituted with R represented by the above Chemical Formula 1 or an anilinium hydrochloride derivative substituted with R represented by the above Chemical Formula 2, and a non-substituted aniline or anilinium hydrochloride derivative in a predetermined molar ratio.

The present invention is more specifically described below, without intending to limit the scope of the present invention.

In order to prepare conductive polyanilines in accordance with the present invention, a reaction temperature of a reactor equipped with a cooling circulator is set to about −10° C., and a mixture containing a protonic acid and an organic solvent is introduced into the reactor in a predetermined ratio and then the reactor is cooled down to the set reaction temperature under stirring.

In this case, 800 Ml of 4 N HCl aq. solution as the protonic acid and 400 Ml of chloroform as the organic solvent are introduced into the reactor and sufficiently stirred up to the set reaction temperature of about −10° C.

HCl is exemplified as the protonic acid in the embodiment of the present invention, but any kind of acid satisfying a condition of pH<4 may be used.

Further, as the organic solvent, any organic solvent that is non-soluble or sparingly soluble in water may be used.

Then, an aniline derivative substituted with R represented by the above Chemical Formula 1 and a non-substituted aniline derivative are added at a predetermined molar ratio into the mixture containing the protonic acid and the organic solvent, and the mixture is dispersed for about 30 to 35 minutes.

A molar ratio of the substituted aniline derivative added to the non-substituted aniline derivative can be adjusted according to a solubility of a product.

In this case, 2-R₁-Phenylamine (wherein R₁ is the same as R defined in the above Chemical Formula 1) and 2-R₂-Phenylamine (wherein R₂ is the same as R defined in the above Chemical Formula 1) as the substituted aniline derivative are respectively added to the non-substituted aniline in a ratio ranging from about 0.5 to about 20 mol %, more preferably 2 to 10 mol %.

Subsequently, a polymerizing reaction is performed by dropwisely adding an initiator solution dissolved in a protonic acid into the reaction mixture in the reactor in which the anilines are dispersed, wherein ammonium persulfate [(NH₄)₂S₂O₈] is used as the initiator and a solution which contains 11.44 g of ammonium persulfate dissolved in 200 Ml of 4M HCl solution is dropwisely added using a dropping funnel for about 25 minutes.

After the polymerizing reaction as described above is terminated, the reaction solution is filtered with 2 μm filter paper (Whatman No.42) and a Buchner funnel to obtain a polymerized product, and the product is washed with acetone and methylene chloride (MC) and is then dedoped in 0.1M NH₄OH (ammonium hydroxide).

Thereafter, the product dedoped with ammonium hydroxide is washed with water and dried in a vacuum oven at a set temperature of about 50° C. for about 48 hours to obtain brown-colored PANI-S₂ and PANI-S₃, respectively which are substituted polyaniline copolymers having the aniline derivative substituted with R represented by the following Chemical Formula 1:

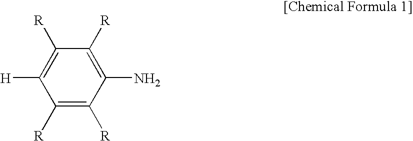

In Chemical Formula 1, R can be H, a hydrophobic —(O)ₘ—(—CE₂—)ₙ—CH₃ in which m is 0 or an integer more than 0 and n is a number from 1 to 24, or a hydrophilic —(—OCH₂CH₂—)_{n′}—O(CE₂)_{m′}CH₃ CH₃ in which m′ is 0 or an integer more than 0 and n′ is an integer equal to or more than 1.

In Chemical Formula 1, at least one R or more can be the hydrophobic —(O)ₘ—(—CH₂—)ₙ—CH₃ in which m is 0 or an integer more than 0 and n is a number from 1 to 24, or the hydrophilic —(—OCH₂CH₂—)_{n′}—O(CH₂)_{m′}CH₃ CH₃ in which m′ is 0 or an integer more than 0 and n′ is an integer equal to or more than 1.

The aniline derivatives in accordance with the present invention can be obtained by the schemes described below.

Syntheses of Aniline Derivatives

<Scheme 1> N-protecting 2-aminophenol (AP-Boc)

In a 1000 Ml round-bottomed flask, 10.9 g (0.1 mol) of 2-aminophenol and 8.8 g (0.15 mol) of NaHCO₃ were dissolved in 100 Ml of distilled water and 100 Ml of tetrahydrofuran (THF), and 22.7 g (0.1 mol) of di-tert-butyl dicarbonate is then added thereto. After a reflux started, the reaction was carried out for 10 hours and then, only a brown solution was obtained using a separation funnel. The obtained brown solution was evaporated to obtain light brown precipitates (yield of 86%).

<Scheme 2> Tosylated R₁ (R₁—Ts)

In a 500 Ml Erlenmeyer flask, 19 g (0.1 mol) of TsCl and 0.15 mol R₁-H compound (here, R₁ is the same as a substituent R defined in the above-described Chemical Formula 1) were dissolved in 200 Ml of THF under stirring. After the solution became transparent, 5 g of NaH (0.12 mol) was gradually added. After the solution turned light violet, it was confirmed that TsCl disappeared using a thin layer chromatography (TLC).

After the reaction was terminated, the solution was made transparent by adding H₂O, evaporated to remove THF and then extracted by adding 200 ml of methylene chloride (MC). The obtained MC layer was evaporated again to obtain a product in a light yellow solution state (yield of 80%).

<Scheme 3> tert-butyl 2-R₁ -phenylcarbamate

In a 500 Ml three neck round bottom flask, 10.45 g (0.05 mol) of AP-Boc and 6.1 g (0.055 mol) of potassium tert-butoxide were dissolved in 200 Ml of THF and heated at a temperature of about 40° C. under stirring in a nitrogen atmosphere.

After the solution turned dark brown, 0.55 mol R₁-Ts dissolved in 50 Ml of THF was dropwisely added thereto. The reaction was continued for about three days, and as a result of a TLC test performed during the reaction, a spot of AP-boc disappeared, which confirmed a termination of the reaction.

After the reaction was terminated, the reaction mixture was treated by suction and evaporation methods to obtain residue, and then the residue was extracted with ethyl acetate (EA) and H₂O at a ratio of 2:1 (v/v) to remove potassium tert-butoxide. The remaining organic layer was evaporated and then separated with a column chromatography using a mixed solvent containing EA:HX (1:4 v/v) (yield of 68%).

<Scheme 4> 2-R₁-phenylamine

In a 500 Ml round-bottomed flask equipped with a condenser, 6.24 g (0.02 mol) of AP-Boc-g-MEE and 40 Ml of dichloromethane were introduced and then 4.56 g (0.04 mol) of TFA in excess was added, followed by stirring. Thereafter, the reaction was implemented at a temperature of about 40° C. for about three hours. After the reaction was terminated, MC and TFA were removed by evaporation at a temperature of 40° C. and a NaHCO₃ aqueous solution was added thereto and then pH was titrated to obtain a neutralized solution. The neutralized solution was extracted by adding ethyl acetate (EA), followed by evaporating so as to remove EA. Accordingly, the product was obtained with a column chromatography using EA:HX (1:3, v/v) (yield of 90%).

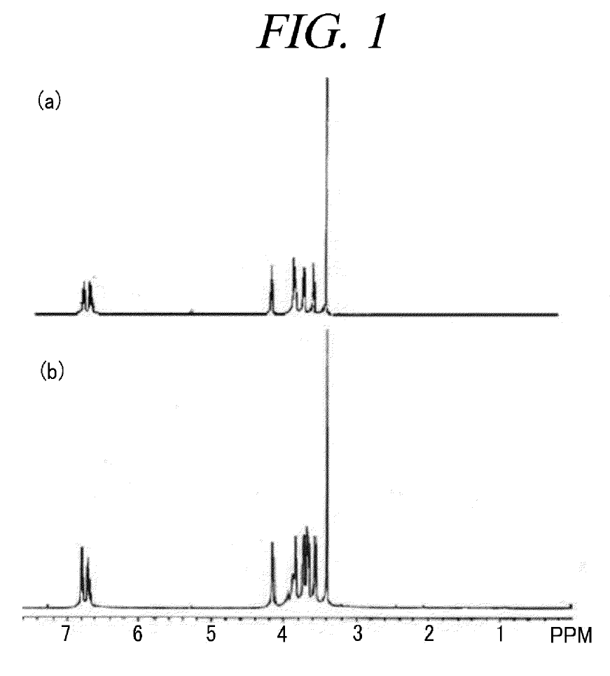

The following schemes illustrate a process of synthesizing the aniline derivative, and a final monomer was confirmed using NMR as illustrated in FIG. 1:

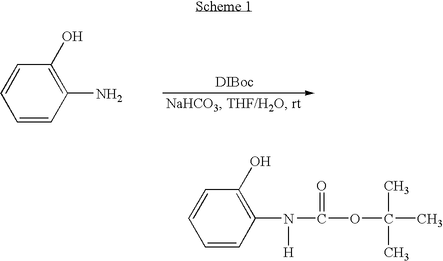

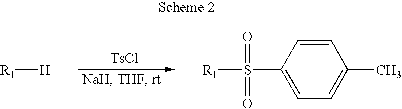

wherein, R₁ is the same as R defined in the above-described Chemical Formula 1;

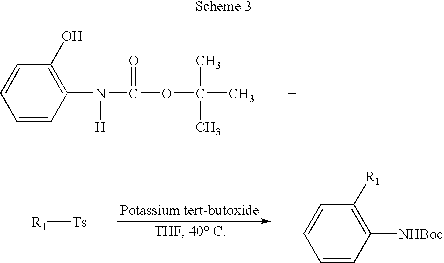

wherein, R₁ is the same as R defined in the above-described Chemical Formula 1;

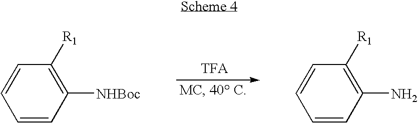

### EXAMPLES

### Example 1

### Synthesis of Substituted Polyanilines, PANI-S₂ and PANI-S₃ in Accordance with the Present Invention

A reaction temperature of a 1000 Ml double jacketed reactor equipped with a cooling circulator was set to about −10° C. About 800 Ml of 4M HCl and about 400 Ml of chloroform were introduced into the reactor and cooled down to the set reaction temperature under stirring. In the mixture containing HCl and chloroform, 20.0 g of aniline monomers were added, the aniline monomers containing a non-substituted aniline and 2-R₁-phenylamine (where, R₁ is —OCH₂CH₂—OCH₂CE₂—OCH₃) and 2-R₂-phenylamine (where, R₂ is ≦OCH₂CH₂—OCH₂CE₂—OCH₂CH₂—OCH₃), respectively, as a substituted aniline derivative, where each of the substituted aniline derivatives was added at set molar ratios of 2 mol %, 5 mol % and 10 mol % respectively, and then the aniline monomers were dispersed for about 30 to 35 minutes. While a solution prepared by dissolving 11.44 g of ammonium persulfate into 200 Ml of 4M HCl was dropwisely added using a dropping funnel in the reactor containing the dispersed anilines for 25 minutes, a polymerizing reaction was implemented until the reaction solution turned from blue to deep navy.

After the polymerizing reaction was terminated, the reaction solution was filtered with 2 μm filter paper and a Buchner funnel so as to obtain the polymerized product, and the product was washed with acetone and MC and then dedoped in 800 Ml of 0.1M NH₄OH solution. Subsequently, the dedoped product was washed with water and dried in a vacuum oven at a set temperature of 50° C. for about 48 hours to obtain brown-colored PANI-S₂ and PANI-S₃, respectively. Here, S₂ and S₃ in PANI-S₂ and PANI-S₃ indicate, respectively, the substituents R₁ and R₂ which are attached to the side chains of the produced polyanilines, wherein the lower case numbers of S₂ and S₃ indicate the number of —OCE₂CH₂ unit in R₁ and R₂, respectively.

### Example 2

### Synthesis of Polyaniline for Comparison to PANI-S₂ and PANI-S₃

A reaction temperature of a 1000 Ml double jacketed reactor equipped with a cooling circulator was set to about −10° C. About 800 Ml of 4M HCl solution and about 400 Ml of chloroform were are introduced into the reactor and cooled down to the set reaction temperature under stirring. 20.0 g of purified aniline was added into the mixture containing hydrochloric acid and chloroform and then dispersed for about 30 to 35 minutes. While a solution prepared by dissolving 11.44 g of ammonium persulfate into 200 Ml of 4M HCl was dropwisely added using a dropping funnel for about 25 minutes into the reactor containing the dispersed aniline, a polymerizing reaction was implemented until the reaction solution turned from blue to deep navy.

After the polymerizing reaction was terminated, the reaction solution was filtered with a 2 μm filter paper and a Buchner funnel so as to obtain the polymerized product, the product was washed with distilled water and methanol to obtain the precipitated product, and the product was dedoped in 800 Ml of 0.1M NH₄OH solution for about 24 hours under stirring. Subsequently, the product was filtered and dried in a vacuum oven at a set temperature of 50° C. for 48 hours to obtain black-colored polyaniline emeraldine base (EB).

### Example 3

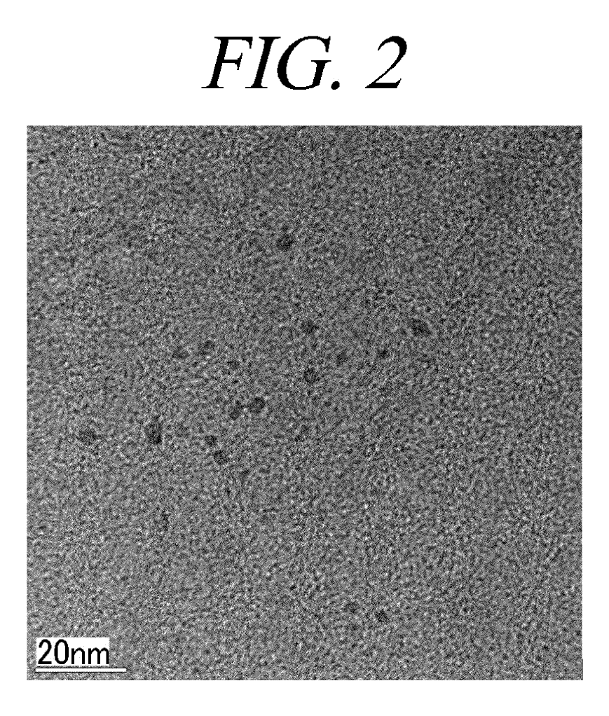

A polymerization reaction was performed in the same manner as in Example 2, except that a reaction temperature was set to 0° C., water and aniline hydrochloride were added in the same volumes and weights instead of 4M HCl and aniline. The obtained EB showed I.V. of 0.96 which is as high as 2 times in comparison with the case using aniline. Also, the particle sizes were in a rage of 7 mm to 30 nm as shown in the TEM (Transmission electron microscopy) image in FIG. 2.

### Example 4

A polymerization reaction was performed in the same manner as in Example 3, except that aniline hydrochloride and 2-R₁-phenylamine (where, R₁ is —OCH₂CH₂—OCH₂CH₂13 OCH₃) as a substituted aniline derivative were mixed in a molar ratio of 9:1. The obtained EB showed I.V. of 0.78.

<Reagent and Apparatus Used in an Experiment of the Present Invention>

(Reagent)

For HCl, NH₄OH, H₂SO₄, THF and TFA used as a solvent in the present invention, their general reagents were used; NaH, NaHCO₃ and potassium tert-butoxide were used as purchased; and chloroform was a first grade reagent produced by Sigma Aldrich Corp. Further, aniline, ammonium persulfate, 2-aminophenol, a R₁—H compound (where, R₁ is —OCH₂CH₂—OCE₂CH₂—OCH₃), a R₂—H compound (where, R₂ is —OCH₂CE₂—OCH₂CH₂—OCE₂CH₂—OCH₃), p-toluene sulfonic chloride and (1S)-(+)-10-camphorsulfuric acid used in a reaction were first grade reagents as purchased from Sigma Aldrich Corp.

(Apparatus)

An IR instrument used for confirming a chemical structure is ┌NICOLET system 800┘; a UV instrument is ┌Jasco V-570┘; ┌Tencor P-10 super surface profiler┘ is used for measuring a thickness; and a spin coater produced by Headway Research Inc. is used for fabricating a spin coating film.

Further, ┌Ubbelohde viscometer┘ produced by Cannon Inc. is used for measuring a viscosity of a polymer at 30° C. Furthermore, ┌Source-Measure Units Model 237┘ produced by Keithley Instruments Inc. is used for measuring electrical conductivity of a polymer film. Moreover, for measuring a TGA and a DSC used for a thermal analysis, ┌TA TGAQ50┘ and ┌DSCQ10┘ are used, and ┌FPAR-1000┘ produced by Photal Otsuka Electronics is used for a particle size analysis. ┌Flash EA1112┘ produced by CE Instruments is used for an element analysis.

### Test Example 1

Viscosity Measurement of Polyaniline Emeraldine Base (EB)

In order to measure a viscosity of a polymer prepared in Example 2, 10 mg of polyaniline (EB) was dissolved in 10 ml of conc. sulphuric acid for about 30 hours to prepare a polymer standard solution. A viscosity of the prepared polymer standard solution was measured with ┌Ubbelohde viscometer┘ at a temperature of about 30° C.

Prior to the viscosity measurement of the polymer standard solution, a viscosity of conc. sulphuric acid was measured at a temperature of about 30° C. and the obtained viscosity was used as a reference for measuring a viscosity of the polymer. The polymer solution and conc. sulphuric acid as a reference solvent were immersed in a thermostat bath for about 1 hour in order to obtain stable measurement temperatures.

$${η}_{inh} = \frac{ln ( η / {η}_{s} )}{c}$$

$${η}_{inh} \text{:} inherent viscosity$$

$$η \text{:} solution viscosity$$

$${η}_{s} \text{:} solvent viscosity$$

$$c \text{:} concentration$$

### Test Example 2

Fabrication of a Polyaniline Film

(1) Preparation of a Polyaniline (ES) Solution

Prior to fabricating a polyaniline film, a polyaniline (ES) solution was prepared as follows.

In order to prepare a polyaniline (ES) solution doped with HCSA[(1S)-(+)-10-camphorsulfuric acid, 99%] produced by Sigma Aldrich Corp., a content of a mixture containing a polyaniline (ES) tetramer unit and HCSA at a molar ratio of 1:2 was set to about 1.5 wt % with respect to m-cresol as a solvent. The polyanilne (EB) and HCSA were mixed uniformly grinding in a mortar for about 30 minutes and the powdered mixture was introduced into m-cresol and dissolved using a homogenizer at a rate of 24,000 rpm for about 10 minutes.

(2) Fabrication of a Polyaniline Film

Using a syringe filter and an injector, non-soluble particles were removed from the solution prepared as described above. A glass plate (2.5cm×2.5cm×0.1 cm) was immersed in a king's water (nitro-hydrochloric acid solution) for about 4 hours and then used after surface was washed with distilled water and ethanol to be used. About 3 Mg of a filtered solution was placed on the glass plate positioned on a hot plate having a set temperature ranging from about 40 to about 50° C. and then dried for about 48 hours or longer so as to fabricate a polyaniline film.

### Test Example 3

Electrical Conductivity Measurement

A resistance of a sample depends on its length and cross-sectional area, and when a DC current and a voltage are applied thereon, the resistance of the sample has a relationship with a DC resistivity as follows:

R=ρL/A

where, ρ denotes a resistivity in a unit of ohms-cm; L denotes a length of the sample in a unit of cm; and A is a cross-sectional area of the sample in a unit of cm².

Each material has its own resistivity. A reciprocal of the DC resistivity is called a DC conductivity in unit of ohms⁻¹cm⁻¹ or S/cm (seimans per cm) as the IUPAC system. The same material fabricated under the same condition has the same DC conductivity, so that DC conductivity can be usefully utilized for differentiating materials from each other.

As for a material having a metallic conductivity, there is a case that an electrical contact resistance formed between a probe and a sample is sometimes greater than a resistance of the sample itself. Therefore, a simple two-probe method has not been widely used. However, such a problem can be solved by using a four-probe method.

Electrical Conductivity Measurement of a Polyaniline Film

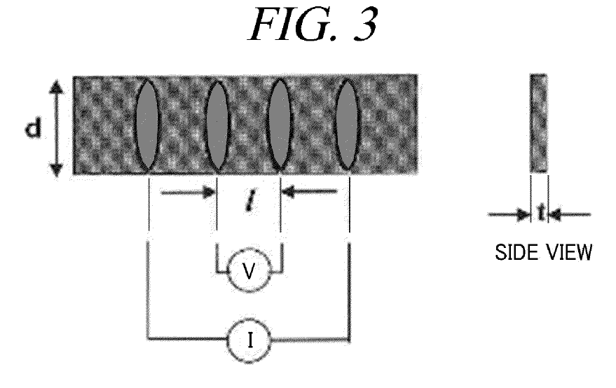

Electrical conductivity of a film fabricated as described above was measured by the four-probe method in order to eliminate a contact resistance formed between a gold wire electrode and a sample (see FIG. 3).

The film was brought into contact with the gold wire using carbon paste, and a thickness of the film was measured using ┌micrometer┘ produced by Mitutoyo.

A current and a voltage were measured using ┌Source-Measure Units Model 237┘ produced by Keithley Instruments Inc. When a constant source current I (DC current) was applied onto two outer probes, a voltage difference V generated due to this was measured at two inner probes. The source currents at the measurement were chosen to be at relatively low levels among 100 μA, 1 mA and 10 mA, based on a range in which a voltage was linearly increased, and the corresponding voltage differences were measured and compared.

The electrical conductivity was calculated using the following equation:

$$σ = \frac{( l ) ( I )}{( dxt ) ( V )}$$

wherein,
σ: Electrical conductivity (S c⁻¹; a reciprocal of Ωcm)
I: Constant source current (DC current) applied onto a sample (A)
V: Voltage measured when a constant source current is applied (V)
t: Film thickness (cm)
l: Distance between electrodes
d: Length of a film in contact with a probe (film width).

Electrical conductivity of a very thin sample such as a semiconductor wafer or a conductive coating was measured using a collinear four-point probe method. The ┌collinear four-point probe┘ was purchased from Jandel Engineering Ltd. This collinear four-point probe was used by connecting with ┌Source-Measure Units Model 237┘ produced by Keithley Instruments Inc. The electrical conductivity was calculated using the following equation:

$$σ ( S / cm ) = ( \frac{ln 2}{π} ) ( \frac{I}{Vxt} )$$

wherein,
σ: Electrical conductivity (S cm⁻¹; a reciprocal of Ωcm)
I: Constant source current (DC current) applied onto a sample (A)
V: Voltage measured when a constant source current is applied (V)
t: Film thickness (cm)

$$\frac{ln 2}{π} \text{:}$$

Electric field factor (constant) generated at four probes (1/C).

TABLE 1
<Electric field factor C depending on film>
shape and film thickness>

| | | | C | C | C |
|---|---|---|---|---|---|
| | C | C | (Rectangle) | (Rectangle) | (Rectangle) |
| d/t^{(a)} | (Circle) | (Square) | m/n^{(b)} = 2 | m/n = 3 | m/n = 4 |
| 1.0 | | | | 0.9988 | 0.9994 |
| 1.5 | | | 1.4788 | 1.4893 | 1.4893 |
| 2.0 | | | 1.9454 | 1.9475 | 1.9475 |
| 3.0 | 2.2662 | 2.4575 | 2.7000 | 2.7005 | 2.7005 |
| 4.0 | 2.9289 | 3.1137 | 3.2246 | 3.2248 | 3.2248 |
| 5.0 | 3.3625 | 3.5098 | 3.5749 | 3.5750 | 3.5750 |
| 10.0 | 4.1716 | 4.2209 | 4.2357 | 4.2357 | 4.2357 |
| 20.0 | 4.4364 | 4.4516 | 4.4533 | 4.4533 | 4.4523 |
| infinite | 4.5324 | 4.5324 | 4.5324 | 4.5324 | 4.5324 |

^{(a)}d: Distance between electrodes of Collinear four-point probe, t: Film thickness
^{(b)}m/n: Length/width of a rectangular film

### Test Example 4

Thermal Analysis of PANI-S₂ and PANI-S₃

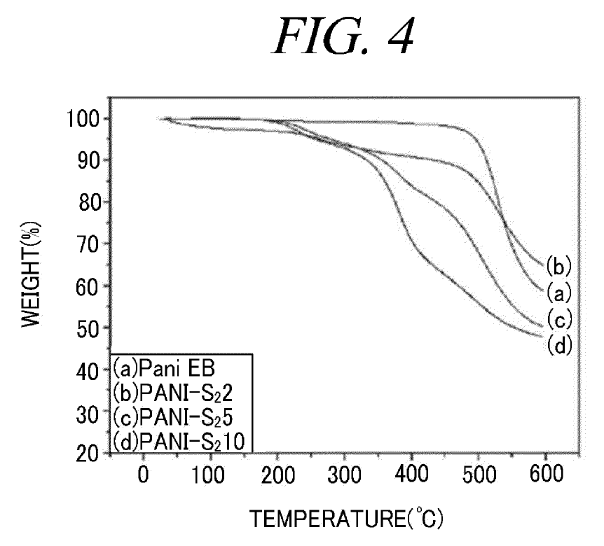

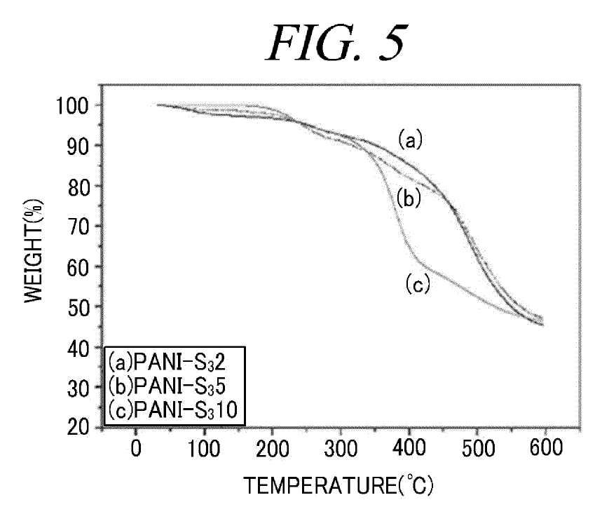

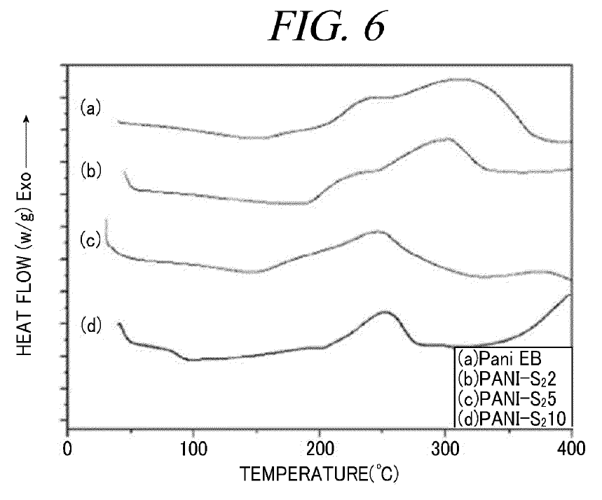

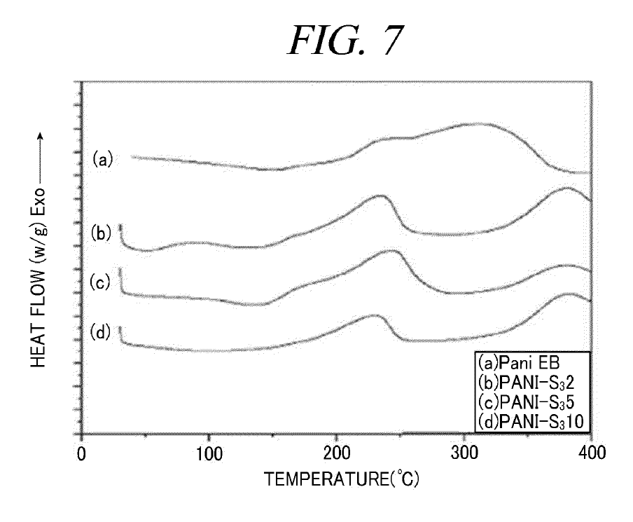

With respect to PANI-S₂ and PANI-S₃ prepared in accordance with the present invention, a thermal stability thereof, whether they were dedoped or not, and a content of side chains therein were measured using a TGA and a DSC in a nitrogen atmosphere. Results obtained by the TGA are shown in FIGS. 4 and 5, and results obtained by the DSC are shown in FIGS. 6 and 7.

The results were obtained for PANI-S₂ and PANI-S₃ polymerized by adding a 2-R₁-phenylamine (where, R₁ is —OCH₂CH₂—OCH₂CH₂—OCH₃) monomer and a 2-R₂-phenylamine (where, R₂ is —OCH₂CH₂—OCH₂CE₂—OCH₂CH₂—OCE₃) monomer to an aniline monomer, respectively, at each molar ratio.

According to the TGA results, unlike the polyaniline (EB) stable to heat up to 400° C., after decomposition ranging from about 4% to about 24% occurs around a temperature of about 250° C. depending on the contents of the monomers having side chains, a thermal decomposition graph becomes similar to that of the polyaniline (EB).

With reference to the DSC data shown in FIGS. 6 and 7, exothermic peaks can be seen around a temperature of about 250° C. In the TGA data, there seems no weight loss of the polyaniline (EB). Accordingly, these can be interpreted as peaks for a crosslinking bond between main chains of the polymers.

Further, it can be seen that a first exothermic peak appears at a lower temperature according to an increase in the amount of side chains. This is because that as copolymers have more amount of side chains, a molecular weight thereof decreases and thus a thermal stability becomes lowered.

### Test Example 5

IR Spectra and H NMR Spectra

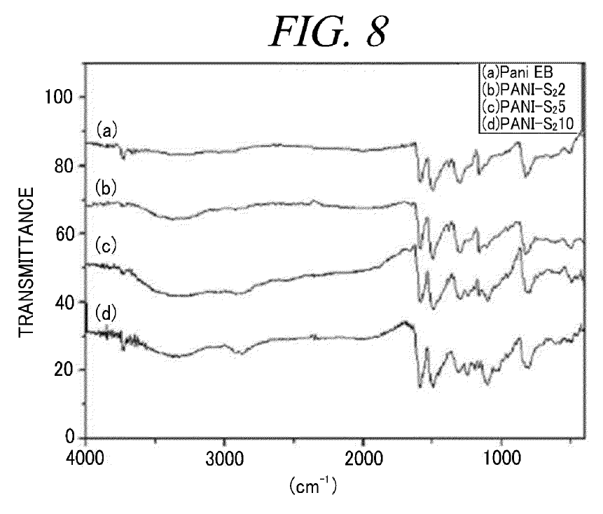

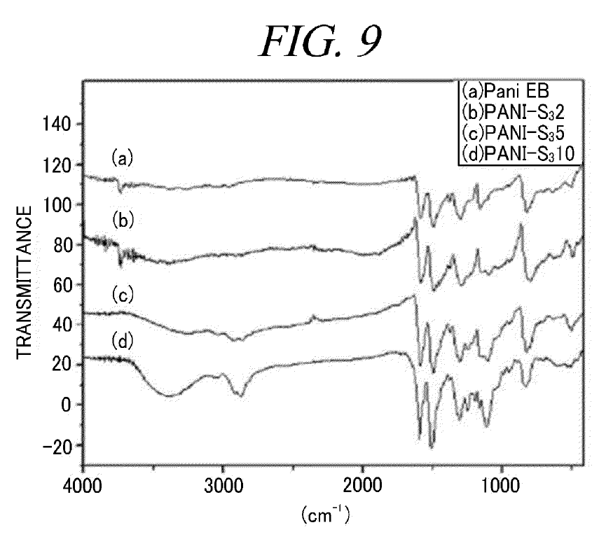

FIGS. 8 and 9 show IR spectra of typical polyaniline-emeraldine base and copolymers according to each molar ratio. There was no significant difference found in peaks of a quinoid ring (1592-1578 cm⁻¹), a benzoid ring (1535-1495 cm⁻¹), a C═N stretching (1310-1290 cm⁻¹), an aromatic C—H in-plane bending (1170-1000 cm⁻¹) and a C—H out-of-plane bending (830 cm⁻¹).

Meanwhile, it can be seen that as a molar ratio of an aniline derivative increases, a peak intensity of a C—O stretching (1200 cm⁻¹) with respect to oxygen connected with a phenyl ring becomes relatively increased.

Further, it can be seen that as the amount of side chains increases, a peak of a C—H stretching band (2925-2853 cm⁻¹) appears distinctly.

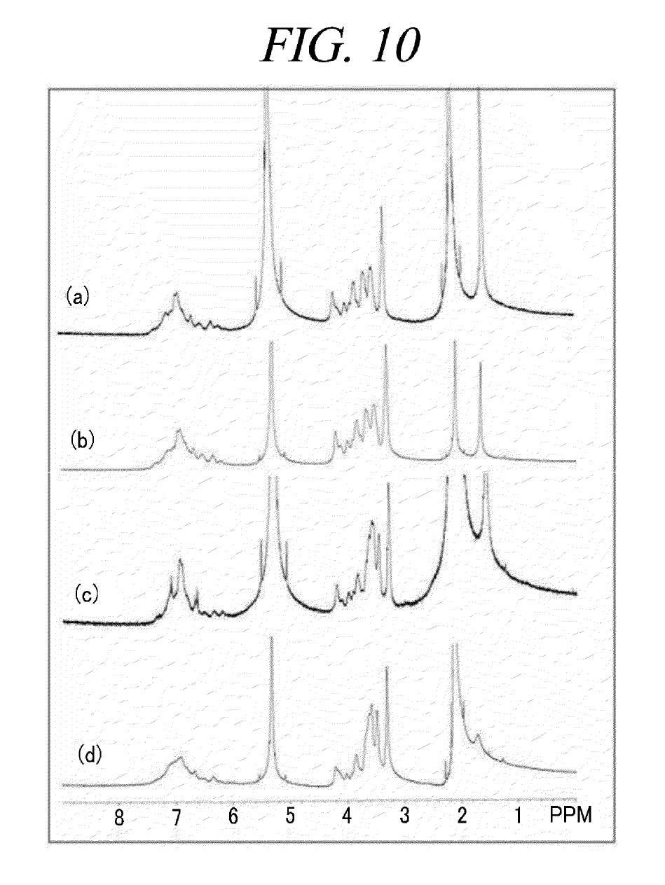

FIG. 10 illustrates NMR spectra of copolymers (EB) polymerized at each ratio of 5 mol % and 10 mol % which have a high solubility in MC. Peaks of phenyl protons (6.2-7.4 ppm) of the polymer backbone and peaks of side chains (3.2-4.2 ppm) were observed and it is confirmed that the copolymers were polymerized using the aniline derivatives.

However, the copolymer (EB) used for NMR measurement was not completely dissolved in the MC, and thus, a content ratio of the side chains could not be obtained.

### Test Example 6

UV-Vis-NIR Spectroscopy

A quartz plate was spin-coated with a NMP solution containing polyaniline (EB) dissolved therein so as to fabricate a thin film having a thickness of about 0.1-0.2 μm. This thin film was analyzed using a UV-Vis-NIR spectroscopy.

Like the polyaniline (EB), the copolymers show an absorption for a p-p* transition at a wavelength of about 330 nm and an absorbance peak for an excitation transition in a range from about 640 nm to about 650 nm.

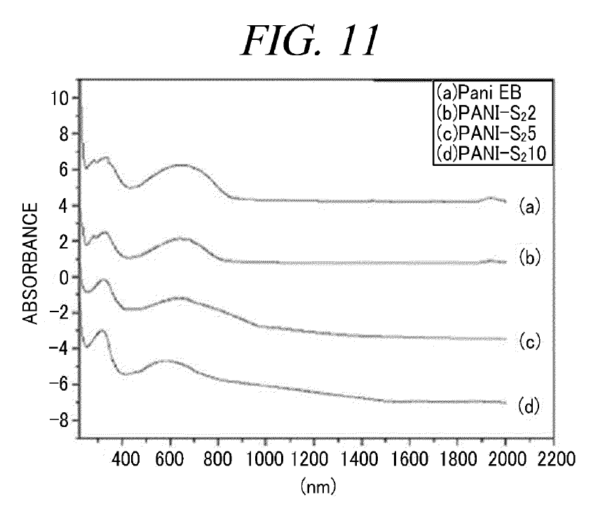

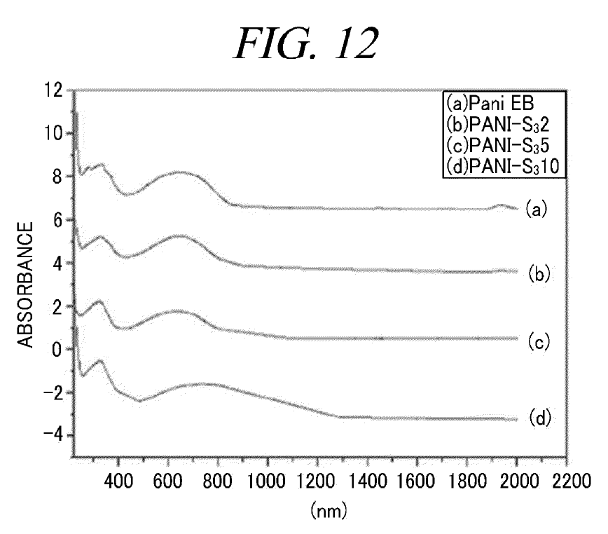

Meanwhile, as can be seen in FIGS. 11 and 12, an absorbance peak slightly moves toward a shorter wavelength side as a molar ratio of side chains increases, and an intensity of an absorbance peak for the excitation transition slightly decreased as compared to that for the p-p* transition.

This result is caused by a steric hindrance such as a non-planar conformation of the polymer main chains due to bulky side chains. The steric hindrance decreases a conjugation length of the polymer main chains, thus resulting in a decrease of conductivity.

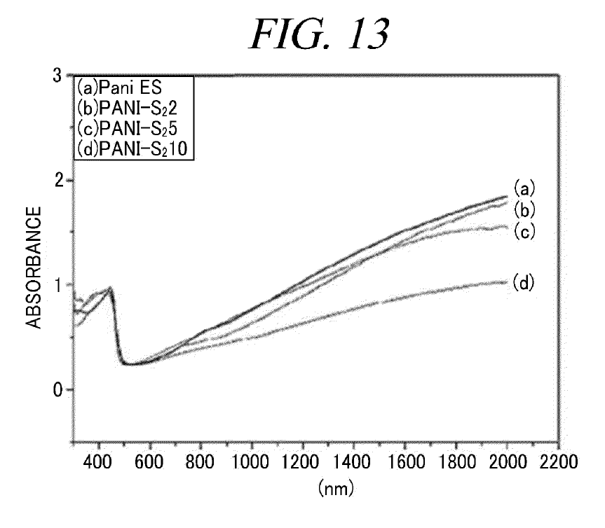

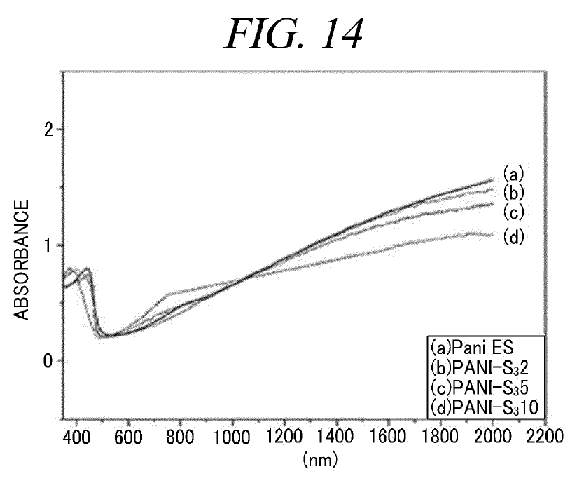

This can be confirmed with reference to FIGS. 13 and 14 showing UV spectra of CSA-doped copolymers. An m-cresol solution containing polyaniline (EB) dissolved therein was spin-coated and the resultant film was analyzed in the same manner as performed on the EB. Wide peaks shown at about 420 nm and near IR range are a polaron peak and a peak for free-carrier tail, respectively.

It can be seen that a height of the free-carrier tail decreases as a length or a molar ratio of side chains increases, which is related to a decrease in conductivity, in comparison with Table 2 described below.

### Test Example 7

Measurements of Electrical Conductivity, Inherent Viscosity and Solubility

Each of polyanililne and copolymers (PANI-S₂, PANI-S₃) polymerized at a temperature of about −10° C. was doped with CSA and then casted on a glass plate washed with king's water (nitro-hydrochloric acid) for about 48 hours or longer, thereby fabricating a film of each polymer. Then, electrical conductivity of each film was measured.

A EB/H₂SO₄ (0.01 g/10 Ml) solution was prepared and inherent viscosity (I.V.) therefor was measured in a thermostat bath set to about 30° C.

The following Table 2 shows electrical conductivity with respect to inherent viscosity (I.V.) obtained for copolymer.

Generally, a molecular weight can be estimated from inherent viscosity. As a whole, it can be seen that as viscosity of the polyaniline increases, electrical conductivity thereof tends to increase and that as a molar ratio and a length of side chains increase, the viscosity and the electrical conductivity tend to decrease.

In this regard, it can be assumed that as the length of the side chains increases, electron transfer between the chains becomes difficult and that as the molar ratio of the side chains increases, the molecular weight and the conjugation length become decreased, resulting in a decrease of the electrical conductivity.

The following Table 3 shows a solubility of each of polyanililne and the copolymers. Each of materials such as 0.02 g of a navy-colored ES doped with HCl obtained after polymerization and 0.02 g of an EB obtained by dedoping the ES with a 0.1M ammonia aq. solution were respectively added in 10 Ml of a solvent and observed for about 24 hours at room temperature under stirring.

In this case, as a molar ratio of the side chains increased and a length of the side chains increased, solubility increased.

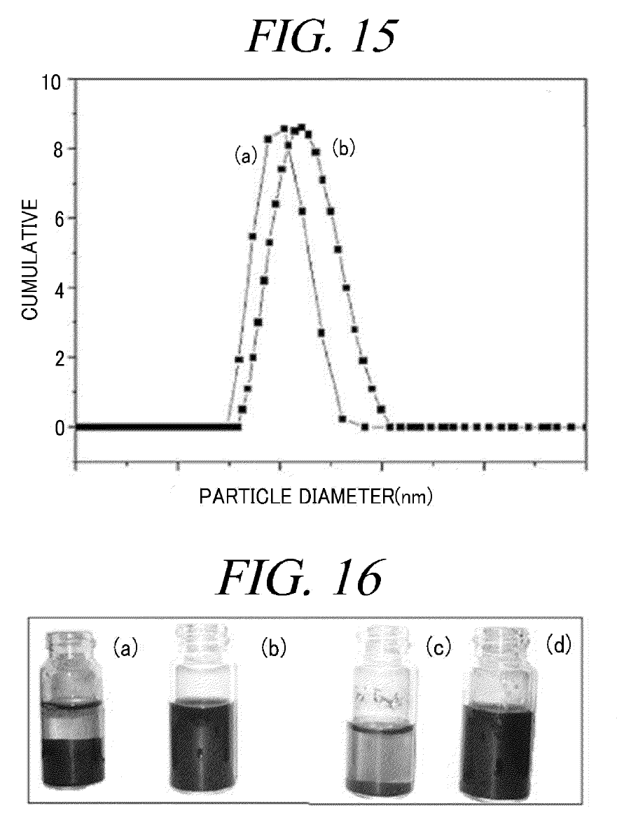

It can be seen that each copolymer emeraldine salt (ES) of a ratio of 10 mol % is dissolved in water (see FIG. 16), and it can be confirmed that each copolymer is dispersed uniformly in this solution at an average size of about 206 nm and about 221 nm, respectively, according to a PSA measurement results obtained for this solution (see FIG. 15).

TABLE 2
<I.V. (Inherent Viscosity) and conductivity
of PANI, PANI-S₂ with 2 mol %, 5 mol % and 10 mol % 2-R₁-
phenylamine, respectively, and PANI-S₃ with 2 mol %, 5 mol % and
10 mol % 2-R₂-phenylamine, respectively>

Solvent Dispersion
Method

| Polymers | | Conductivity |
|---|---|---|
| Polymers | I.V. | (S/cm) |
| PANI | 1.58 | 392 |

| | | | |
|---|---|---|---|
| PANI-S₂ | 2 mol % | 1.52 | 290 |
| PANI-S₂ | 4 mol % | 2.05 | 263 |
| PANI-S₂ | 5 mol % | 1.47 | 209 |
| PANI-S₂ | 10 mol % | 1.27 | 30 |
| PANI-S₃ | 2 mol % | 1.43 | 240 |
| PANI-S₃ | 5 mol % | 1.31 | 189 |
| PANI-S₃ | 10 mol % | 1.28 | 60 |

TABLE 3
<Solubility of PANI, PANI-S₂ and PANI-S₃>

| Polymers | PANI | | PANI-S₂ | | | | | | PANI-S₃ | | | | | |
|---|---|---|---|---|---|---|---|---|---|---|---|---|---|---|
| Polymers | PANI | | 2 mol % | | 5 mol % | | 10 mol % | | 2 mol % | | 5 mol % | | 10 mol % | |
| Solvents | EB | ES | EB | ES | EB | ES | EB | ES | EB | ES | EB | ES | EB | ES |
| DMSO | ^{c}Δ | — | Δ | — | Δ | — | ◯ | — | Δ | — | ◯ | — | ◯ | — |
| DMF | ^{a}⊚ | — | ⊚ | — | ⊚ | — | ⊚ | — | ⊚ | — | ⊚ | — | ⊚ | — |
| NMP | ⊚ | — | ^{b}◯ | — | ⊚ | — | ⊚ | — | ⊚ | — | ⊚ | — | ⊚ | — |
| CHCl₃ | ^{d}X | — | X | — | X | — | X | — | X | — | Δ | — | Δ | — |
| Acetone | Δ | X | Δ | X | Δ | X | Δ | X | Δ | X | Δ | X | Δ | X |
| MC | Δ | Δ | Δ | Δ | ◯ | X | ⊚ | X | Δ | X | ◯ | X | ⊚ | X |
| MeOH | X | X | X | Δ | Δ | ◯ | ◯ | ⊚ | X | Δ | Δ | ◯ | ◯ | ⊚ |
| Water | X | X | X | X | X | X | X | ⊚ | X | X | X | Δ | X | ⊚ |

^{a}⊚: Highly soluble
^{b}◯: Soluble
^{c}Δ: Slightly soluble
^{d}X: Non-soluble

In the present invention, a substituted polyaniline copolymer is synthesized by adding an aniline derivative having a side chain in order to increase solubility of polyaniline, and a chemical structure thereof is confirmed by the NMR and IR measurements.

Further, in order to increase a molecular weight, a self-dispersion polymerizing method is used and the polymerization is performed with varying a length of side chains and a molar ratio of the aniline derivatives. The molecular weight of each of the polyaniline and the copolymers is estimated from their inherent viscosities. Further, electrical conductivity is measured for a casting film fabricated after doping each polymers and copolymers with HCSA.

As a result of such measurements, it is confirmed that as the contents of the aniline derivatives having side chain(s) increase, the molecular weights of the copolymers decrease referring to the inherent viscosity and that a thermal stability decreases due to this referring to the DSC and the TGA data.

Furthermore, it can be seen that as the molar ratio or the length of the side chains in the polyaniline copolymers (such as PANI-S₂ and PANI-S₃) prepared in accordance with the present invention increase, they have an improved solubility in a general solvent, as compared to the conventional polyanilines. In particular, the polyaniline copolymer (ES) polymerized with a ratio of 10 mol % of a substituted aniline derivative is dispersed in water at a uniform size of about 220 nm, which indicates a possibility to compensate for disadvantages that the conventional polyanilines can be processed by dissolving them only in a toxic solvent.

It can be seen that the polyaniline copolymers prepared in accordance with the present invention have a low crystallinity or viscosity as compared to the conventional polyanilines, a steric hindrance due to their side chains affects on a conjugation length, and electrical conductivity decreases. However, the polyaniline copolymers prepared in accordance with the present invention still have a high electrical conductivity (up to 290 S/cm) as compared to conventional substituted polyanilines.

What is claimed is:

1. A method for preparing a conductive polyaniline, comprising the steps of:
(a) providing a mixture containing a protonic acid and an organic solvent in a predetermined ratio into the reactor, and cooling the reactor down to the set reaction temperature while stirring the mixture;
(b) adding an aniline derivative substituted with R represented by the following Chemical Formula 1: 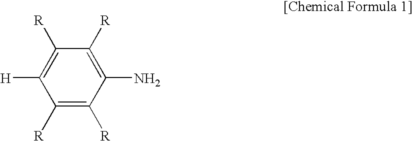
wherein,
each R is independently HE, a hydrophobic —(O)ₘ—(—CH₂—)ₙ—CH₃ in which m is 0 or an integer more than 0 and n is a number from 5 to 24, or, a hydrophilic —(—OCE₂CH₂—)_{n′}—O(CH₂)_{m′}CH₃ CH₃ in which m′ is 0 or an integer more than 0 and n′ is an integer equal to or more than 1, providing that each R is not simultaneously H and a non-substituted aniline of a predetermined molar ratio into the mixture containing the protonic acid and the organic solvent and then dispersing the resulting mixture for 30 to 35 minutes;
(c) performing a polymerizing reaction by dropwisely adding an initiator solution dissolved in a protonic acid into the reactor where the anilines are dispersed;
(d) terminating the polymerizing reaction followed by filtering the reaction solution to obtain a product from the polymerizing reaction, washing the product with a washing solvent, and then dedoping the product; and
(e) washing the product with water followed by drying to obtain a substituted polyaniline copolymer.

2. The method according to claim 1, wherein pH of the protonic acid is less than 4.

3. The method according to claim 1, wherein the organic solvent is non-soluble or sparingly soluble in water.

4. The method according to claim 1, wherein a molar ratio of the aniline derivative substituted with R mixed with the non-substituted aniline is controlled with respect to a solubility of an obtained polyaniline.

5. A conductive polyaniline, which is prepared from a mixture containing an aniline derivative substituted with R represented by the following Chemical Formula 1 and a non-substituted aniline in a predetermined molar ratio using the method according to claim 1: 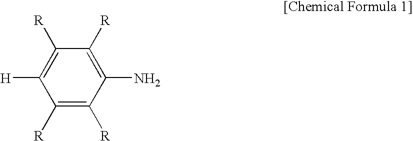
wherein,
each R is independently H, a hydrophobic —(O)ₘ—(—CH₂—)ₙ—CH₃ in which m is 0 or an integer more than 0 and n is a number from 5 to 24, or, a hydrophilic —(—OCH₂CH₂—)_{n′}—O(CH₂)_{m′}CH₃ CH₃ in which m′ is 0 or an integer more than 0 and n′ is an integer equal to or more than 1, providing that each R is not simultaneously H.

6. The conductive polyaniline according to claim 5, wherein at least one R in the Chemical Formula 1 is a hydrophobic —(O)ₘ—(—CH₂—)ₙ—CH₃ in which m is 0 or an integer more than 0 and n is a number from 5 to 24, or, a hydrophilic —(—OCH₂CH₂—)_{n′}—O(CH₂)_{m′}CH₃ CH₃ in which m′ is 0 or an integer more than 1 and n′ is an integer equal to or more than 1.

7. A conductive polyaniline, which is prepared from a monomer mixture containing an aniline derivative substituted with R represented by Chemical Formula 1 as defined in claim 1 or an anilinium hydrochloride derivative substituted with R represented by the following Chemical Formula 2, and a non-substituted aniline or anilinium hydrochloride derivative in a predetermined molar ratio, using the method according to claim 1: 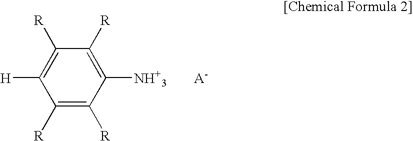
wherein, each R is independently HE, a hydrophobic —(O)ₘ—(—CE₂—)ₙ—CH₃ in which m is 0 or an integer more than 0 and n is a number from 5 to 24, or a hydrophilic —(—OCH₂CE₂—)_{n′}—O(CE₂)_{m′}CH₃ CE₃ in which m′ is 0 or an integer more than 0 and n′ is an integer equal to or more than 1, providing that each R is not simultaneously H.

8. A method for preparing a conductive polyaniline, comprising the steps of:
(a) stirring a mixture comprising a protonic acid and an organic solvent in a predetermined ratio at a set reaction temperature;
(b) adding an aniline derivative substituted with R represented by the following Chemical Formula 1 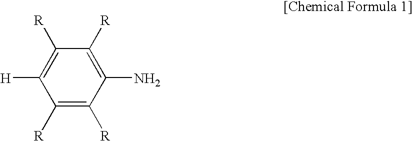
wherein,
each R is independently H, a hydrophobic —(O)ₘ—(—CH₂—)ₙ—CH₃ in which m is 0 or an integer more than 0 and n is a number from 5 to 24, or, a hydrophilic —(—OCE₂CH₂—)_{n′}—O(CH₂)_{m′}CH₃ CH₃ in which m′ is 0 or an integer more than 0 and n′ is an integer equal to or more than 1, providing that each R is not simultaneously H, and a non-substituted aniline of a predetermined molar ratio into the mixture to create a dispersion;
(c) reacting the dispersed anilines by dropwise addition of an initiator dissolved in a protonic acid;
(d) terminating the reaction;
(e) isolating, washing and dedoping the resulting reaction product; and
(f) drying the reaction product to obtain a substituted polyaniline copolymer.

9. A conductive polyaniline copolymer prepared by the process of claim 8.

10. A conductive polyaniline, which is the reaction product of an aniline derivative substituted with R represented by the following Chemical Formula 1 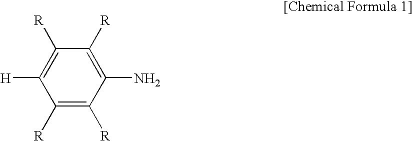
wherein,
each R is independently H, a hydrophobic —(O)ₘ—(—CH₂—)ₙ—CH₃ in which m is 0 or an integer more than 0 and n is a number from 5 to 24, or, a hydrophilic —(—OCH₂CH₂—)_{n′}—O(CH₂)_{n′}CH₃ CH₃ in which m′ is 0 or an integer more than 0 and n′ is an integer equal to or more than 1, providing that each R is not simultaneously H and a non-substituted aniline in a predetermined molar ratio.
